(19) United States
(12) Patent Application Publication
(10) Pub. No.: US 2021/0380248 A1
(43) Pub. Date: Dec. 9, 2021

(54) MOISTURE WICKING EXPANDABLE SLEEVE

(71) Applicant: The Boeing Company, Chicago, IL (US)

(72) Inventor: Darren Carl McIntosh, Mukilteo, WA (US)

(21) Appl. No.: 16/892,591

(22) Filed: Jun. 4, 2020

(51) Int. Cl. B64D 11/00; B64F 5/10

(52) U.S. Cl. CPC B64D 11/00; B64F 5/10

(57) ABSTRACT

A method and system of moisture control for a cabin of an aircraft comprising an expandable sleeve receivable over a structural member. The expandable sleeve has a material with moisture absorbing properties and elastic properties. The expandable sleeve is configured to absorb moisture flowing down the structural member. The sleeve is easily installed by stretching the sleeve to its expanded state to fit over the structural member and returning the sleeve to its contracted state to fit snugly around the structural member such that moisture flowing down the structural member does not seep into the cabin of the aircraft. Moisture is wicked and/or absorbed into the sleeve, dries, and then the process repeats when needed. No use of heat is required.

### BACKGROUND INFORMATION

### 1. Field

The present disclosure relates generally to moisture control in aircraft compartments. More specifically, the present disclosure relates to a moisture wicking expandable sleeve for use in an aircraft cabin.

### 2. Background

Moisture control in an aircraft cabin is essential to maintaining comfortable flying conditions for passengers. During operation of the aircraft, condensation collects in the upper crown area of the fuselage between the cold outer skin and the insulated cabin wall. Such condensation flows down connecting structural members in the fuselage. For instance, condensation may flow down the tie rods that connect cabin interior linings to the fuselage skin.

As this condensate flows downward, it may drip through gaps in the cabin interior linings and fall on passengers. The condensate also may damage cabin interior furnishings, electrical equipment, and the like. This phenomenon is commonly known as “rain in the plane.”

Many currently used moisture control systems installed in these locations cannot sufficiently collect condensation, or such systems require multi-step installation methods. Therefore, it would be desirable to have a method and apparatus that takes into account at least some of the issues discussed above, as well as other possible issues.

### SUMMARY

An illustrative embodiment of the present disclosure provides a moisture control system for a cabin of an aircraft. The moisture control system comprises an expandable sleeve receivable over a structural member. The expandable sleeve comprises a material having moisture absorbing properties. The moisture control system is configured to absorb moisture that flows down the structural member during operation of the aircraft.

Another illustrative embodiment of the present disclosure provides a method for moisture control in a cabin of an aircraft. A sleeve having moisture absorbing properties and elastic properties expands from a contracted state to an expanded state to receive a structural member. The sleeve contracts to the contracted state to conform to a contour of the structural member without the application of heat.

A further illustrative embodiment of the present disclosure provides an aircraft having a tie rod associated with a cabin of the aircraft and a moisture control system. The moisture control system comprises an expandable sleeve configured to receive the tie rod. The expandable sleeve comprises a material having moisture absorbing properties and elastic properties.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a cross-sectional view of an aircraft cabin in accordance with an illustrative embodiment;

FIG. 2 is an illustration of a block diagram of an aircraft in accordance with an illustrative embodiment;

FIG. 3 is an illustration of a moisture control system with an expandable sleeve in accordance with an illustrative embodiment;

FIG. 4 is an illustration of a moisture control system with an expandable sleeve installed on a tie rod in accordance with an illustrative embodiment;

FIG. 5 is another illustration of a moisture control system with an expandable sleeve in accordance with an illustrative embodiment;

FIG. 6 is yet another illustration of a moisture control system with an expandable sleeve in accordance with an illustrative embodiment;

FIGS. 7A-7D are illustrations of section views of material for an expandable sleeve while in an expanded state in accordance with an illustrative embodiment;

FIGS. 8A-8D are illustrations of section views of material for an expandable sleeve while in a contracted state in accordance with an illustrative embodiment;

FIG. 9 is an illustration of an expandable sleeve with slits in accordance with an illustrative embodiment;

FIG. 10 is an illustration of a flowchart of a process for moisture control in a cabin of an aircraft in accordance with an illustrative embodiment;

FIG. 11 is an illustration of a block diagram of an aircraft manufacturing and service method in accordance with an illustrative embodiment; and

FIG. 12 is an illustration of a block diagram of an aircraft in which an illustrative embodiment may be implemented.

### DETAILED DESCRIPTION

The illustrative embodiments recognize and take into account one or more different considerations. For example, the illustrative embodiments recognize and take into account that depending on altitude, number of passengers, or other considerations, the volume of condensation flowing down structural members varies. Some currently used moisture control systems do not wick away moisture in a desired manner, or do not dry out quickly enough to capture consistent moisture flow. For example, some tie rods are wrapped with a single circular strip or ring of felt, which is ineffective in preventing rain in the plane. In these examples, the felt gets saturated quickly. Spirally wrapping felt around the tie rod is also an option; however, this solution takes manpower and consistency in application is difficult to achieve.

The illustrative embodiments also recognize and take into account that some currently used solutions require multiple installation steps to complete. For example, when using a pre-manufactured heat shrinking sleeve, the moisture control system must be installed on the structural member and then shrunk with a heat gun. Adding steps to the aircraft assembly process costs manufacturers time, money, and requires a powered appliance (heat gun).

The illustrative embodiments further recognize and take into account that when using heat shrinking materials for moisture control purposes, the materials cannot be re-used if the structural member needs to be removed or reworked. In this manner, the heat shrinking materials are single use. If rework occurs, manufacturers are forced to install new material over the structural member.

Thus, the disclosed embodiments provide a moisture control system having an expandable sleeve receivable over a structural member. The expandable sleeve has a material with moisture absorbing properties and elastic properties. The expandable sleeve is configured to absorb moisture that flows down the structural member. The expandable sleeve may be stretched from its contracted condition to an expanded condition to receive the structural member. Once positioned over the structural member, the expandable sleeve returns to its contracted condition to fit snuggly around the structural member. No use of heat is required to conform to the size irregularities of the structural member.

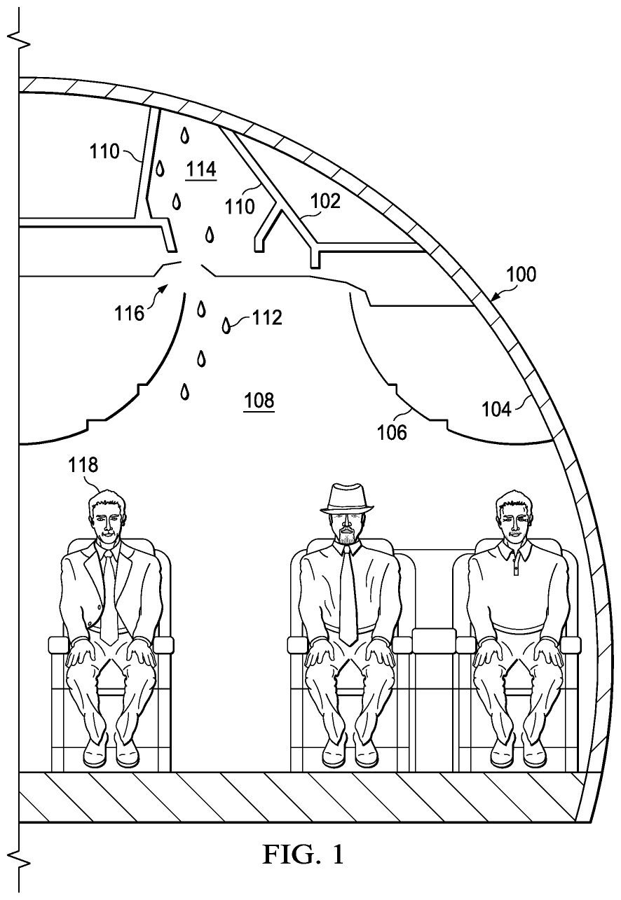

With reference now to the figures and, in particular, with reference to FIG. 1, an illustration of a cross-sectional view of an aircraft cabin is depicted in accordance with an illustrative embodiment. FIG. 1 depicts a partial cross section of fuselage 100. Fuselage 100 includes support structures 102. Support structures 102 connect fuselage skin 104 to interior panels 106 of passenger cabin 108.

As depicted, support structures 102 include a number of structural members 110, such as tie rods or similar vertical and/or angular upper supports. A “number of” when used with reference to items means one or more items. Thus, a number of structural members is one or more structural members.

In this illustrative example, condensation 112 collects in space 114 between fuselage skin/frames 104 and interior panels 106. Condensation 112 flows down structural members 110 during operation of the aircraft and may seep through gap 116 between interior panels 106 and drip onto passengers 118.

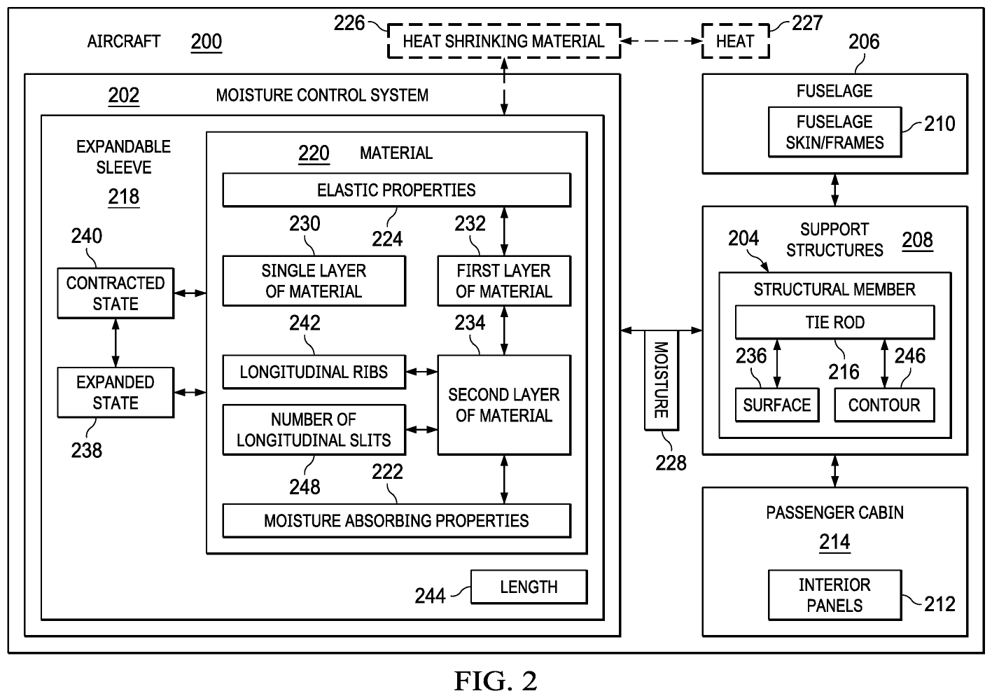

Fuselage 100 in an example of a portion of an aircraft in which a moisture control system may be implemented in accordance with an illustrative embodiment. The components shown in fuselage 100 in FIG. 1 are examples of physical implementations for components in aircraft 200 shown in block form in FIG. 2.

Turning now to FIG. 2, an illustration of a block diagram of an aircraft is depicted in accordance with an illustrative embodiment. Aircraft 200 is a platform where moisture control system 202 is associated with structural member 204.

In this illustrative example, aircraft 200 comprises fuselage 206 with support structures 208. Support structures 208 are structural components configured to connect fuselage skin/frames 210 with interior panels 212 of passenger cabin 214. Structural member 204 is one of support structures 208. Structural member 204 may take the form of tie rod 216 in this illustrative example.

As illustrated, moisture control system 202 is associated with structural member 204. Moisture control system 202 comprises expandable sleeve 218 configured to receive structural member 204. Expandable sleeve 218 uses a predetermined length of tubing or material. Expandable sleeve 218 comprises material 220 having moisture absorbing properties 222 and elastic properties 224.

In this illustrative example, material 220 may take a variety of different forms. For example, without limitation, material 220 may comprise at least one of felt, corduroy, a mesh, a super-absorbent polymer, a silica gel, a natural fiber, wool, cotton, bamboo, a microfiber, polyester, polyurethane, rayon, an acrylic or acrylonitrile, a combination thereof, or other suitable types of materials.

As used herein, the phrase “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, “at least one of item A, item B, or item C” may include, without limitation, item A, item A and item B, or item C. This example also may include item A, item B, and item C, or item B and item C. Of course, any combination of these items may be present. In other examples, “at least one of” may be, for example, without limitation, two of item A, one of item B, and ten of item C; four of item B and seven of item C; or other suitable combinations.

As used herein, felt is a textile that is produced by matting, condensing, and pressing fibers together. Felt can be made of natural fibers or from synthetic fibers. Blended fibers may also be employed.

Material 220 is devoid of heat shrinking material 226. In other words, material 220 is configured to contract without the application of heat 227.

Moisture absorbing properties 222 of material 220 ensure that enough moisture 228 is wicked away from structural member 204. Ideally, all moisture 228 flowing down structural member 204 will be absorbed by material 220. As used herein, “moisture” and “condensation” or “condensate” are used interchangeably.

Elastic properties 224 allow material 220 to stretch such that expandable sleeve 218 can receive structural member 204. Once expandable sleeve 218 surrounds structural member 204, elastic properties 224 return material 220 to its original condition, contracting around structural member 204.

In this illustrative example, expandable sleeve 218 may comprise single layer of material 230. When expandable sleeve 218 comprises single layer of material 230, both moisture absorbing properties 222 and elastic properties 224 are found in the same layer.

In other illustrative examples, expandable sleeve 218 may comprise first layer of material 232 and second layer of material 234. First layer of material 232 is a substrate base layer. First layer of material 232 is associated with surface 236 of structural member 204 (i.e. tie rod 216). First layer of material 232 has elastic properties 224 and is configured to expand to receive structural member 204. For example, without limitation, first layer of material 232 may take the form of foam, plastic, a polyether-polyurea copolymer (elastane), rubber, latex, or some other expandable material.

First layer of material 232 returns from expanded state 238 to contracted state 240. Contracted state 240 is the original state for first layer of material 232. First layer of material 232 returns from expanded state 238 to contracted state 240 without the application of heat 227.

When two layers of material 220 are present, second layer of material 234 is adhered to first layer of material 232. Second layer of material 234 may be adhered to first layer of material 232 by bonding, adhesive, sewing, or in some other suitable fashion. For example, first layer of material 232 may be woven with second layer of material 234. Second layer of material 234 may take the form of felt, corduroy, bamboo, merino wool, cotton, or some other suitable absorbent materials. These natural fibers may be combined/woven with the elastic material to maintain elasticity.

Other illustrative examples may include a microfiber polyester fabric woven with a polyether-polyurea copolymer to provide an elastic and absorbent material in a mesh or non-mesh configuration. The advantage of the microfiber polyester material is its moisture wicking properties with a high evaporation rate. Other examples of woven/layered materials may include a warp knit fabric laminated to a monolithic film. Still other examples may include elastane woven with nylon or elastane woven with cotton.

In this depicted example, material 220 may comprise longitudinal ribs 242 running parallel to length 244 of expandable sleeve 218. Longitudinal ribs 242 separate as material 220 expands to receive structural member 204. Longitudinal ribs 242 collapse as material 220 contracts to conform to contour 246 of structural member 204.

In some illustrative examples, material 220 may comprise number of longitudinal slits 248 cut into second layer of material 234 and running parallel to length 244 of expandable sleeve 218. Number of longitudinal slits 248 allow second layer of material 234 to conform to elastic properties 224 of first layer of material 232 in a desired manner.

In other illustrative examples, expandable sleeve 218 may have more than two layers. In still other illustrative examples, material 220, already having elastic properties 224, may be impregnated with a polymer having moisture absorbing properties 222.

Material 220 may be spirally wound on a tube or other structure comprising expandable sleeve 218. In other illustrative examples, material 220 may be positioned on said tube or structure in some other manner. Spirally winding material 220 enhances the wicking of moisture 228 because material 220 dries as it absorbs along length 244 of expandable sleeve 218 and allows greater air-drying surface area.

During installation, expandable sleeve 218 is expanded to fit over structural member 204, then allowed to contract down to the surface of structural member 204. In this manner, expandable sleeve 218 works as a sock or a sheath for structural member 204.

Although the illustrative embodiments are described with reference to aircraft 200, moisture control system 202 may be applicable to other types of platforms as well. For example, without limitation, moisture control system 202 may be implemented in a mobile platform, a stationary platform, a land-based structure, an aquatic-based structure, or a space-based structure. More specifically, the platform may be a surface ship, a tank, a personnel carrier, a train, a spacecraft, a space station, a satellite, a submarine, an automobile, a power plant, a bridge, a dam, a house, a manufacturing facility, a building, or some other suitable platforms where moisture control considerations are present.

With an illustrative embodiment, moisture control system 202 provides enough absorption of moisture 228 to prevent rain in the plane. Expandable sleeve 218 provides moisture wicking down the entire length 244 of structural member 204. The illustrative embodiments provide a reusable solution to moisture control for tie rods or other types of support structures 208 in aircraft 200. Since no heat is necessary to shrink expandable sleeve 218, and the sleeve is pre-manufactured instead of spirally wrapped during installation of structural member 204, fewer assembly steps are required, which saves manpower hours and money. The process ensures consistency and optimal performance, in contrast to a manual application of felt or another material to structural member 204 where human error may occur.

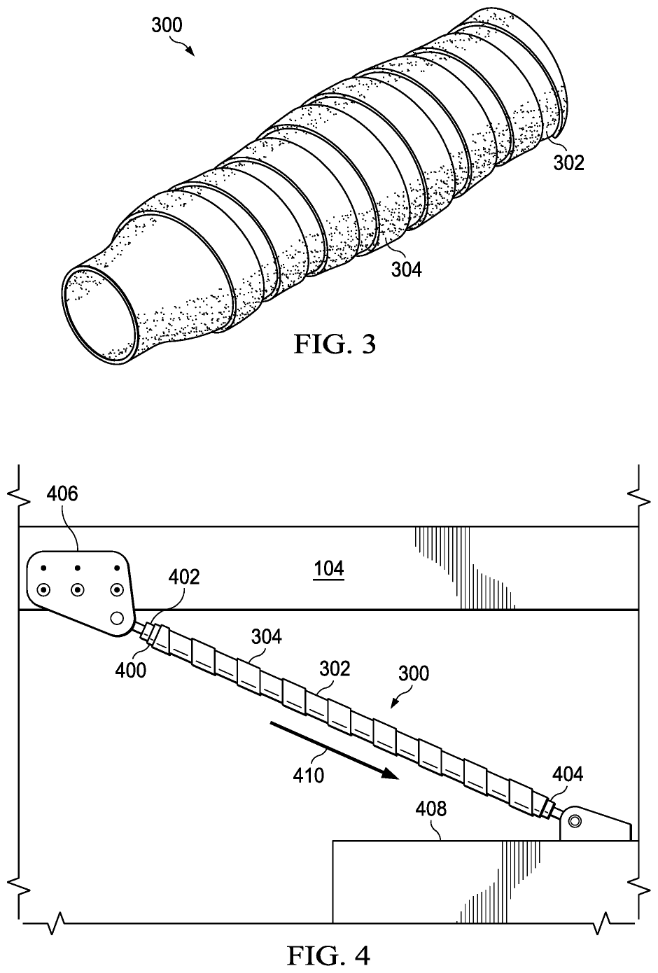

With reference next to FIG. 3, an illustration of a moisture control system with an expandable sleeve is depicted in accordance with an illustrative embodiment. Sleeve 300 comprises two layers of material in this illustrative example. Sleeve 300 has material 302 as a substrate base and material 304 spirally wrapped around material 302. Sleeve 300 and the components described herein are examples of physical implementations of expandable sleeve 218 and its components in moisture control system 202 shown in block form in FIG. 2. Material 302 has elastic properties while material 304 has moisture absorbing properties. Sleeve 300 is shown in its original contracted state in this illustrative example.

Turning now to FIG. 4, an illustration of a moisture control system with an expandable sleeve installed on a tie rod is depicted in accordance with an illustrative embodiment. In this depicted example, tie rod 400 has upper end 402 and lower end 404. Upper end 402 of tie rod 400 is connected to fuselage structure 406. Lower end 404 of tie rod 400 is connected to feature 408. Feature 408 may be an interior panel, a galley, a lavatory, a closet, or the like. Condensation 112 flows down tie rod 400 in the direction of arrow 410.

As illustrated, sleeve 300 has been installed over tie rod 400. Sleeve 300 contracts to the contour of tie rod 400 to fit snugly around tie rod 400. As condensation 112 flows in the direction of arrow 410, material 304 absorbs condensation 112 down the length of tie rod 400 to prevent rain on the plane.

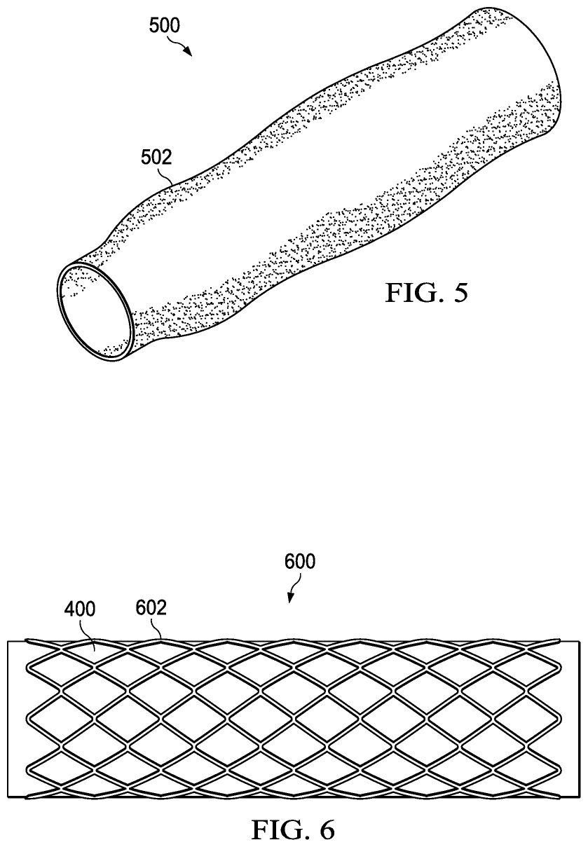

In FIG. 5, another illustration of a moisture control system with an expandable sleeve is depicted in accordance with an illustrative embodiment. Sleeve 500 is made of material 502. Sleeve 500 and the components described herein are examples of physical implementations of expandable sleeve 218 and its components in moisture control system 202 shown in block form in FIG. 2.

A single type of material 502 provides both elastic properties and moisture absorbing properties. No more than one layer may be necessary in this illustrative example.

FIG. 6 shows yet another illustration of a moisture control system with an expandable sleeve depicted in accordance with an illustrative embodiment. In this illustrative example, sleeve 600 takes the form of mesh 602. Sleeve 600 and the components described herein are examples of physical implementations of expandable sleeve 218 and its components in moisture control system 202 shown in block form in FIG. 2.

As illustrated, mesh 602 may be comprised of a felt weave. Mesh 602 may be applied down the entire length of tie rod 400 in a continuous manner (i.e., one continuous sleeve) or in strips or multiple separated sections. Sleeve 600 provides a radially expandable weave or mesh pattern in this illustrative example.

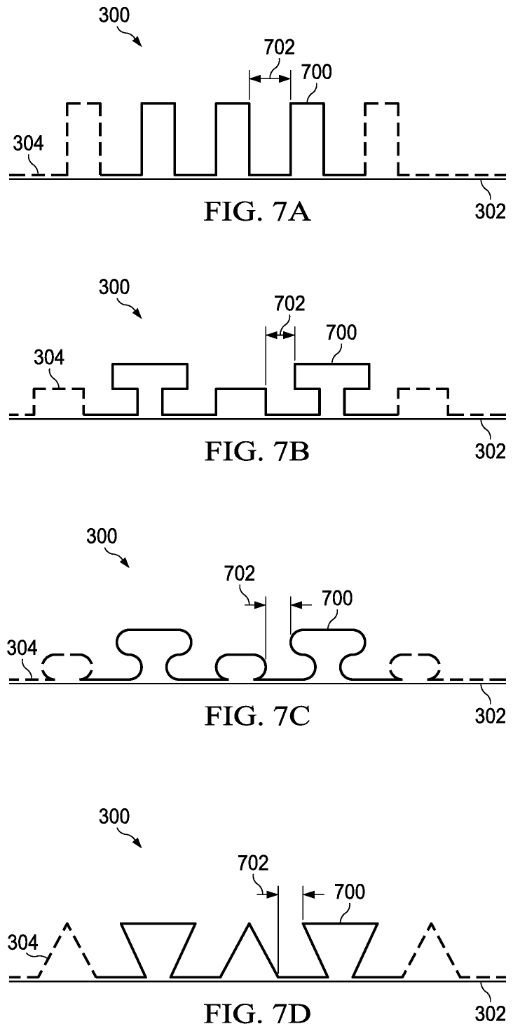

In FIGS. 7A-7D, illustrations of section views of material for an expandable sleeve in an expanded state are depicted in accordance with an illustrative embodiment. In this illustrative example, material 304 in sleeve 300 has longitudinal ribs 700.

Longitudinal ribs 700 may take the form of a corduroy covering atop material 302. The covering may be a continuous fabric with ribs extending from a base fabric web or individual felt ribs. The covering or ribs may be applied or adhered to material 302 during an extrusion process with sleeves, then cut to a predetermined length for use. Of course, other materials may be used other than a corduroy covering.

The cross-sectional shape of longitudinal ribs 700 may take a variety of different forms. For example, without limitation, the cross-sectional shape of longitudinal ribs 700 may be rectangular, triangular, trapezoidal, circular, irregular, or have some other suitable shape. Different shapes for longitudinal ribs 700 are shown in FIGS. 7A-7D. The expanded state of sleeve 300 occurs as sleeve 300 is stretched to accommodate tie rod 400. Longitudinal ribs 700 are spaced circumferentially around sleeve 300.

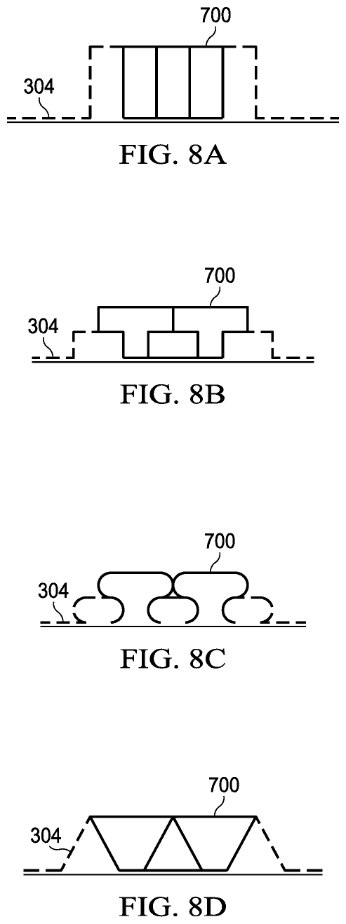

Prior to stretching, longitudinal ribs 700 resemble the configuration shown in FIGS. 8A-8D. Longitudinal ribs 700 have separation distance 702 between one another when stretched. Separation distance 702 may vary depending on the amount of elasticity of material 302 and/or the amount of stretching that needs to be done to accommodate tie rod 400. In this manner, sleeve 300 is versatile and can conform to varying thicknesses and contours of tie rod 400. Separation distance 702 has two functions, this distance allows sleeve 300 to stretch, and also allows greater air-drying surface area longitudinally.

With reference next to FIGS. 8A-8D, illustrations of section views of material for an expandable sleeve in a contracted state are depicted in accordance with an illustrative embodiment. In this depicted example, the different shapes of longitudinal ribs 700 are shown in a contracted state.

Longitudinal ribs 700 have this configuration prior to the stretching of sleeve 300 and after sleeve 300 receives tie rod 400 and returns to its substantially contracted state. In some illustrative examples, sleeve 300 may not be able to return to its fully contracted state and some separation distance 702 may remain between two longitudinal ribs 700, depending on the thickness of tie rod 400.

As illustrated, longitudinal ribs 700 contract radially, resulting in gathering about the circumference of sleeve 300, providing substantially continuous circumferential coverage of contracted sleeve 300 for maximum condensate capture. The different shapes of longitudinal ribs 700 may be complementary such that adjacent longitudinal ribs 700 may be received against or within their respective shapes.

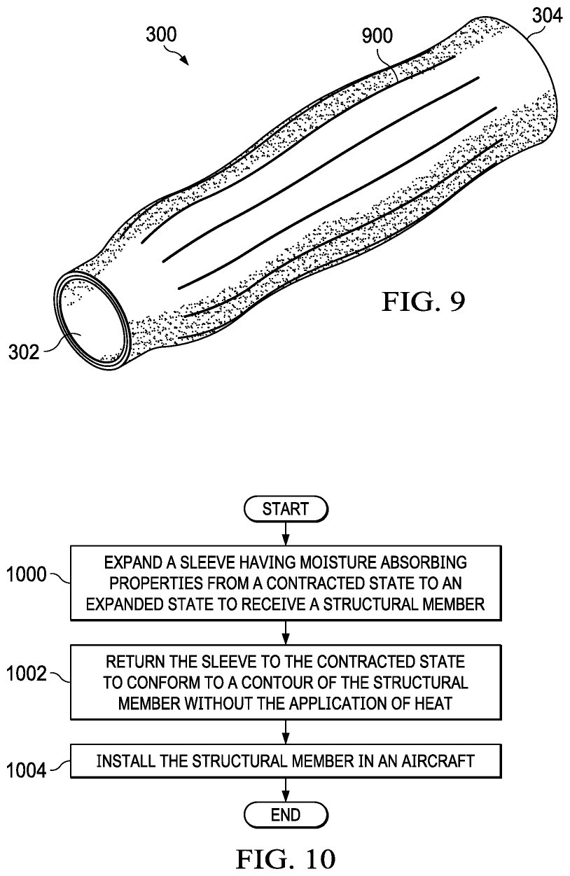

Turning to FIG. 9, an illustration of an expandable sleeve with slits is depicted in accordance with an illustrative embodiment. In this illustrative example, instead of longitudinal ribs 700, material 304 has slits 900 cut in different locations. Slits 900 allow for expansion of material 302 without compromising the integrity of material 304. Slits 900 may be applied during a secondary manufacturing process once extruded.

The different components shown in FIG. 1 and FIGS. 3-9 may be combined with components in FIG. 2, used with components in FIG. 2, or a combination of the two. Additionally, some of the components in FIG. 1 and FIGS. 3-9 may be illustrative examples of how components shown in block form in FIG. 2 may be implemented as physical structures.

Other configurations of moisture control system 202 may be implemented other than those shown in FIG. 1 and FIGS. 3-9. The configurations described herein are not meant to be limiting as to the placement, orientation, type, or configuration of any component in moisture control system 202.

With reference next to FIG. 10, an illustration of a flowchart of a process for moisture control in a cabin of an aircraft is depicted in accordance with an illustrative embodiment. The method depicted in FIG. 10 may be used to install moisture control system 202 over structural member 204 in FIG. 2.

The process begins by expanding a sleeve having moisture absorbing properties from a contracted state to an expanded state to receive a structural member (operation 1000). When the sleeve comprises a material having longitudinal ribs running parallel to a length of the sleeve, operation 1000 includes separating the longitudinal ribs as the material expands.

Next, the process returns the sleeve to the contracted state to conform to a contour of the structural member without the application of heat (operation 1002). When longitudinal ribs are present, operation 1002 includes collapsing the longitudinal ribs as the material contracts.

The process then installs the structural member in an aircraft (operation 1004), with the process terminating thereafter. The application of the sleeve may be completed after the structural member is installed in the aircraft or prior to the structural member being installed in the aircraft.

When rework or inspection needs to be completed in that area of the aircraft, the sleeve may be removed from the structural member prior to reworking or inspecting the structural member. The same sleeve may then be re-installed around the reworked structural member, as described in operations 1000-1004.

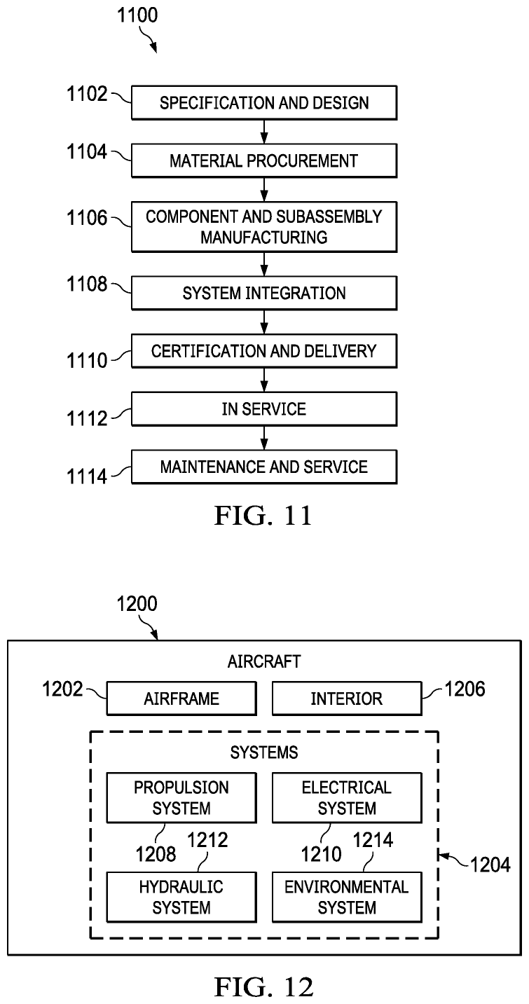

Accordingly, the illustrative embodiments of the disclosure may be described in the context of aircraft manufacturing and service method 1100 as shown in FIG. 11 and aircraft 1200 as shown in FIG. 12. Turning first to FIG. 11, an illustration of a block diagram of an aircraft manufacturing and service method is depicted in accordance with an illustrative embodiment. During pre-production, aircraft manufacturing and service method 1100 may include specification and design 1102 of aircraft 1200 in FIG. 12 and material procurement 1104.

During production, component and subassembly manufacturing 1106 and system integration 1108 of aircraft 1200 in FIG. 12 takes place. Thereafter, aircraft 1200 in FIG. 12 may go through certification and delivery 1110 in order to be placed in service 1112. While in service 1112 by a customer, aircraft 1200 in FIG. 12 is scheduled for routine maintenance and service 1114, which may include modification, reconfiguration, refurbishment, and other maintenance, service, or inspection.

Moisture control system 202 with expandable sleeve 218 from FIG. 2 may be installed around structural member 204 during component and subassembly manufacturing 1106. In addition, moisture control system 202 with expandable sleeve 218 may be removed and reapplied to structural member 204 during routine maintenance and service 1114, inclusive of inspection, as part of a modification, reconfiguration, or refurbishment of aircraft 1200 in FIG. 12.

Each of the processes of aircraft manufacturing and service method 1100 may be performed or carried out by a system integrator, a third party, an operator, or some combination thereof. In these examples, the operator may be a customer. For the purposes of this description, a system integrator may include, without limitation, any number of aircraft manufacturers and major-system subcontractors; a third party may include, without limitation, any number of vendors, subcontractors, and suppliers, and an operator may be an airline, a leasing company, a military entity, a service organization, and so on.

With reference now to FIG. 12, an illustration of a block diagram of an aircraft is depicted in which an illustrative embodiment may be implemented. In this example, aircraft 1200 is produced by aircraft manufacturing and service method 1100 in FIG. 11 and may include airframe 1202 with plurality of systems 1204 and interior 1206. Examples of systems 1204 include one or more of propulsion system 1208, electrical system 1210, hydraulic system 1212, and environmental system 1214. Any number of other systems may be included. Although an aerospace example is shown, different illustrative embodiments may be applied to other industries, such as the automotive industry.

Apparatuses and methods embodied herein may be employed during at least one of the stages of aircraft manufacturing and service method 1100 in FIG. 11. In one illustrative example, components or subassemblies produced in component and subassembly manufacturing 1106 in FIG. 11 may be fabricated or manufactured in a manner similar to components or subassemblies produced while aircraft 1200 is in service 1112 in FIG. 11. As yet another example, one or more apparatus embodiments, method embodiments, or a combination thereof may be utilized during production stages, such as component and subassembly manufacturing 1106 and system integration 1108 in FIG. 11. One or more apparatus embodiments, method embodiments, or a combination thereof may be utilized while aircraft 1200 is in service 1112, during maintenance and service 1114, inclusive of inspection, in FIG. 11, or both. The use of a number of the different illustrative embodiments may substantially expedite the assembly of aircraft 1200, reduce the cost of aircraft 1200, or both expedite the assembly of aircraft 1200 and reduce the cost of aircraft 1200.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added, in addition to the illustrated blocks, in a flowchart or block diagram.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A moisture control system for a cabin of an aircraft comprising:
an expandable sleeve receivable over a structural member, the expandable sleeve comprising a material having moisture absorbing properties, wherein the moisture control system is configured to absorb moisture on the structural member.

2. The moisture control system of claim 1, wherein the expandable sleeve is devoid of a heat shrinking material.

3. The moisture control system of claim 2, wherein the expandable sleeve comprises:
a single layer of the material having the moisture absorbing properties and elastic properties.

4. The moisture control system of claim 3, wherein the material comprises:
longitudinal ribs running parallel to a length of the expandable sleeve, wherein the longitudinal ribs separate as the material expands to receive the structural member and collapse as the material contracts to conform to a contour of the structural member.

5. The moisture control system of claim 2, wherein the material forming the expandable sleeve returns from an expanded state to a contracted state without an application of heat.

6. The moisture control system of claim 5, wherein the expandable sleeve comprises:
a first layer of material associated with a surface of the structural member, wherein the first layer of material has elastic properties and is configured to expand to receive the structural member; and
a second layer of material adhered to the first layer of material and comprising the moisture absorbing properties.

7. The moisture control system of claim 6, wherein the first layer of material comprises a polyether-polyurea copolymer and the second layer of material comprises a microfiber polyester, and wherein the first layer of material is woven with the second layer of material.

8. The moisture control system of claim 1, wherein the expandable sleeve comprises a mesh having a felt weave.

9. The moisture control system of claim 1, wherein the material is impregnated with a polymer having the moisture absorbing properties.

10. A method for moisture control in a cabin of an aircraft, the method comprising:
expanding a sleeve having moisture absorbing properties from a contracted state to an expanded state to receive a structural member; and
returning the sleeve to the contracted state to conform to a contour of the structural member.

11. The method of claim 10, wherein returning the sleeve to the contracted state is completed without an application of heat.

12. The method of claim 10 further comprising:
installing the structural member in the aircraft after application of the sleeve.

13. The method of claim 10 further comprising:
installing the structural member in the aircraft prior to application of the sleeve.

14. The method of claim 10 further comprising:
removing the sleeve from the structural member;
reworking the structural member; and
re-installing the sleeve around the structural member.

15. The method of claim 10, wherein the sleeve comprises a material having longitudinal ribs running parallel to a length of the sleeve, and further comprising:
separating the longitudinal ribs as the material expands; and
collapsing the longitudinal ribs as the material contracts.

16. An aircraft comprising:
a tie rod associated with a cabin of the aircraft; and
a moisture control system comprising an expandable sleeve configured to receive the tie rod, wherein the expandable sleeve comprises a material having moisture absorbing properties.

17. The aircraft of claim 16, wherein the expandable sleeve is devoid of a heat shrinking material.

18. The aircraft of claim 17, wherein the expandable sleeve comprises:
a single layer of the material having the moisture absorbing properties and elastic properties.

19. The aircraft of claim 18, wherein the material comprises:
longitudinal ribs running parallel to a length of the expandable sleeve, wherein the longitudinal ribs separate as the material expands to receive the tie rod and collapse as the material contracts to conform to a contour of the tie rod.

20. The aircraft of claim 16, wherein the expandable sleeve comprises:
a first layer of material associated with a surface of the tie rod, wherein the first layer of material has elastic properties as is configured to expand to receive the tie rod; and
a second layer of material adhered to the first layer of material and comprising the moisture absorbing properties, wherein the first layer of material returns from an expanded state to a contracted state without an application of heat.
